(19) United States
(12) Patent Application Publication
(10) Pub. No.: US 2013/0191833 A1
(43) Pub. Date: Jul. 25, 2013

(54) SYSTEM AND METHOD FOR ASSURING PERFORMANCE OF DATA SCRUBBING OPERATIONS

(71) Applicants: Gary B. Kotzur, Austin, TX (US); Surender Brahmaroutu, Round Rock, TX (US)

(72) Inventors: Gary B. Kotzur, Austin, TX (US); Surender Brahmaroutu, Round Rock, TX (US)

(73) Assignee: DELL PRODUCTS L.P., Round Rock, TX (US)

(21) Appl. No.: 13/355,637

(22) Filed: Jan. 23, 2012

(51) Int. Cl. G06F 9/46; G06F 1/32

(52) U.S. Cl. 718/102

(57) ABSTRACT

A method may include determining based on at least one data scrubbing parameter associated with at least one storage resource that the at least one storage resource is scheduled for a data scrubbing operation. The method may also include cause the at least one storage resource to transition from a low-power mode to a normal-power mode in order to perform a data scrubbing operation in response to a determination that the at least one storage resource is scheduled for a data scrubbing operation. The method may additionally include determining based on the at least one data scrubbing parameter that the data scrubbing operation is scheduled to cease. The method may further comprise causing the at least one storage resource to transition from the normal-power mode to the low-power mode in response to a determination that the data scrubbing operation is scheduled to cease.

### TECHNICAL FIELD

The present disclosure relates in general to information handling systems, and more particularly to assurance performance of data scrubbing operations in storage resources.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often use an array of physical storage resources, such as a Redundant Array of Independent Disks (RAID), for example, for storing information. Arrays of physical storage resources typically utilize multiple disks to perform input and output operations and can be structured to provide redundancy which may increase fault tolerance. Other advantages of arrays of physical storage resources may be increased data integrity, throughput and/or capacity. In operation, one or more physical storage resources disposed in an array of physical storage resources may appear to an operating system as a single logical storage unit or “logical unit.”Implementations of physical storage resource arrays can range from a few physical storage resources disposed in a server chassis, to hundreds of physical storage resources disposed in one or more separate storage enclosures.

In some storage resource redundancy schemes, some storage resources may from time to time be powered down or placed in a low-power “standby” state, in order to conserve power.

Storage resources often use data scrubbing as an error correction technique. Data scrubbing typically runs as a background task that periodically inspects storage resources for errors, and then corrects the error using error correction code (ECC) memory or another copy of the data. It reduces the likelihood that single correctable errors will accumulate; thus, reducing the risk of uncorrectable errors. In RAID, a RAID controller periodically reads all the disks in a RAID array and checks for defective blocks before they are actually accessed by applications. This reduces the probability of silent data corruption and data loss due to bit errors.

However, using traditional approaches, data scrubbing cannot be used by standby storage resources, as their low-power state may prevent data scrubbing operations from executing.

### SUMMARY

In accordance with the teachings of the present disclosure, the disadvantages and problems associated with assuring the performance of data scrubbing in storage resources have been reduced or eliminated.

In embodiments of the present disclosure, a storage array may comprise a management controller and at least one storage resource communicatively coupled to the management controller. The at least one storage resource may be configured to operate in each of a normal-power mode, in which the storage resource consumes sufficient power to perform input/output (I/O) operations and a low-power mode, in which the storage resource consumes sufficient power to perform management operations but not I/O operations. The at least one storage resource may have associated therewith at least one data scrubbing parameter defining a schedule for data scrubbing operations of the at least one storage resource. The management controller and the at least one storage resource may further configured to: (i) cause the at least one storage resource to transition from the low-power mode to the normal-power mode in order to perform a data scrubbing operation in response to a determination based on the at least one data scrubbing parameter that the at least one storage resource is scheduled for a data scrubbing operation; and (ii) cause the at least one storage resource to transition from the normal-power mode to the low-power mode in response to a determination based on the at least one data scrubbing parameter that the data scrubbing operation is scheduled to cease.

In additional embodiments of the present disclosure, an information handling system may include a processor, a management controller, and at least one storage resource communicatively coupled to the processor and the management controller. The at least one storage resource may be configured to operate in each of a normal-power mode, in which the storage resource consumes sufficient power to perform input/output (I/O) operations and a low-power mode, in which the storage resource consumes sufficient power to perform management operations but not I/O operations. The at least one storage resource may have associated therewith at least one data scrubbing parameter defining a schedule for data scrubbing operations of the at least one storage resource. The management controller and the at least one storage resource may further configured to: (i) cause the at least one storage resource to transition from the low-power mode to the normal-power mode in order to perform a data scrubbing operation in response to a determination based on the at least one data scrubbing parameter that the at least one storage resource is scheduled for a data scrubbing operation; and (ii) cause the at least one storage resource to transition from the normal-power mode to the low-power mode in response to a determination based on the at least one data scrubbing parameter that the data scrubbing operation is scheduled to cease.

In accordance with further embodiments of the present disclosure, a method may include determining based on at least one data scrubbing parameter associated with at least one storage resource that the at least one storage resource is scheduled for a data scrubbing operation. The method may also include cause the at least one storage resource to transition from a low-power mode to a normal-power mode in order to perform a data scrubbing operation in response to a determination that the at least one storage resource is scheduled for a data scrubbing operation. The method may additionally include determining based on the at least one data scrubbing parameter that the data scrubbing operation is scheduled to cease. The method may further comprise causing the at least one storage resource to transition from the normal-power mode to the low-power mode in response to a determination that the data scrubbing operation is scheduled to cease. In the normal-power mode, the storage resource consumes sufficient power to perform input/output (I/O) operations. In the low-power mode, the storage resource consumes sufficient power to perform management operations but not I/O operations.

Technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram of an example system for assuring performance of data scrubbing operations, in accordance with certain embodiments of the present disclosure;

FIG. 2 illustrates a flow chart of an example method for a storage resource-initiated data scrubbing operation of a standby storage resource, in accordance with the present disclosure; and

FIG. 3 illustrates a flow chart of an example method for a management controller-initiated data scrubbing operation of a standby storage resource, in accordance with the present disclosure.

### DETAILED DESCRIPTION

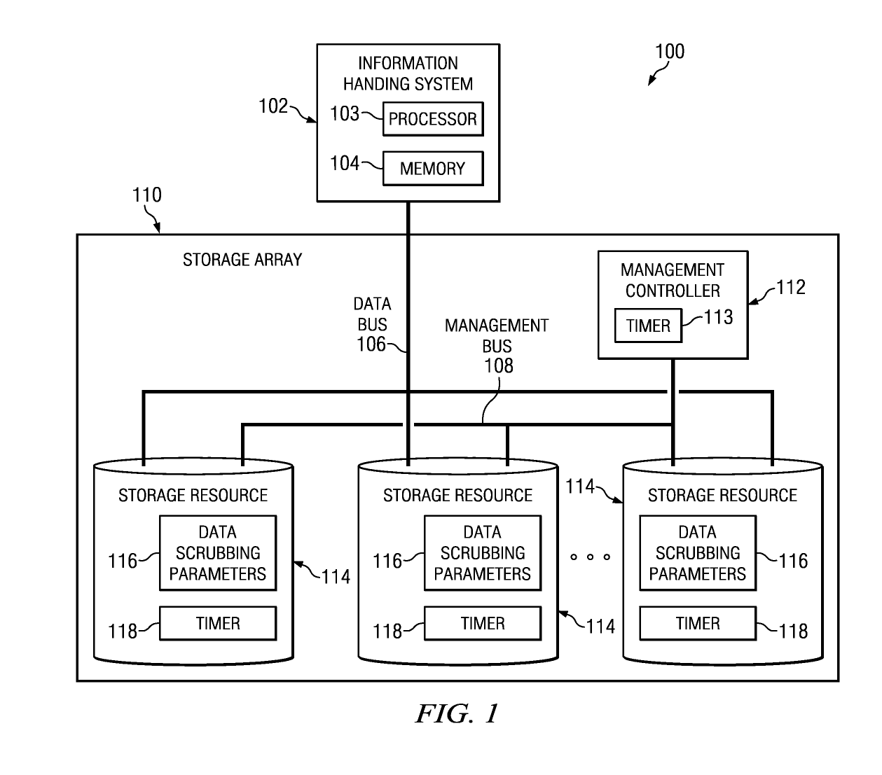

Preferred embodiments and their advantages are best understood by reference to FIGS. 1-3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

An information handling system may include or may be coupled to an array of physical storage resources. The array of physical storage resources may include a plurality of physical storage resources, and may be operable to perform one or more input and/or output storage operations, and/or may be structured to provide redundancy. In operation, one or more physical storage resources disposed in an array of physical storage resources may appear to an operating system as a single logical storage unit or “virtual storage resource.”

In certain embodiments, an array of physical storage resources may be implemented as a Redundant Array of Independent Disks (also referred to as a Redundant Array of Inexpensive Disks or a RAID). RAID implementations may employ a number of techniques to provide for redundancy, including striping, mirroring, and/or parity generation/checking. As known in the art, RAIDs may be implemented according to numerous RAID levels, including without limitation, standard RAID levels (e.g., RAID 0, RAID 1, RAID 3, RAID 4, RAID 5, and RAID 6), nested RAID levels (e.g., RAID 01, RAID 03, RAID 10, RAID 30, RAID 50, RAID 51, RAID 53, RAID 60, RAID 100), non-standard RAID levels, or others.

FIG. 1 is a block diagram of an example system 100 for assuring performance of data scrubbing operations, in accordance with certain embodiments of the present disclosure. As depicted in FIG. 1, system 100 may include an information handling system 102 and a storage array 110 communicatively coupled to information handling system 102 via a data bus 106.

Information handling system 102 may generally be operable to receive data from and/or communicate data to storage array 110. In certain embodiments, information handling system 102 may be a server. In another embodiment, information handling system 102 may be a personal computer (e.g., a desktop computer or a portable computer). In yet other embodiments, information handling system 102 may comprise a storage sub-system (e.g., a storage array and/or storage enclosure). As depicted in FIG. 1, information handling system 102 may include a processor 103 and a memory 104 communicatively coupled to processor 103.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off.

Data bus 106 may comprise any system, device, or apparatus configured to transfer data between storage array 110 and information handling system 102. Data bus 106 may comprise parallel electrical wires with multiple connections or any physical arrangement that provides the same logical functionality as a parallel electrical bus (e.g., parallel, bit-serial, multidrop, daisy chain, switched hubs, etc.). In some embodiments, data bus 106 may include may comprise a Peripheral Component Interconnect Express (PCIe) bus, Serial Attached Small Computer System Interface (SAS) bus, Serial Advanced Technology Attachment (SATA), Universal Serial Bus (USB), or another suitable bus.

Storage array 110 may comprise any system, device, or apparatus having a plurality of physical storage resources 114 communicatively coupled to information handling system 102 via data bus 106. Storage resources 114 may include hard disk drives, magnetic tape libraries, optical disk drives, magneto-optical disk drives, compact disk drives, compact disk arrays, disk array controllers, and/or any computer-readable medium operable to store data. In particular embodiments, one or more storage resources 114 may comprise solid-state storage devices. In some embodiments, storage resources 114 may form all or part of a redundant storage array (e.g., a RAID). In such embodiments, storage resources 114 participating in the redundant storage array may appear to an operating system executing on information handling system 102 as a single logical storage unit or virtual resource. Thus, information handling system 102 may “see” a logical unit instead of seeing each individual physical storage resource 114. Although FIG. 1 depicts storage resources 114 as components of system 100 separate from information handling system 102, in some embodiments, one or more storage resources 114 may be integral to information handling system 102. Storage resources 114 may be housed in one or more storage enclosures configured to hold and power storage resources 114.

As shown in FIG. 1, a storage resource 114 may include data scrubbing parameters 116 and a timer 118. Data scrubbing parameters 116 may include a list, table, map, database, and/or other suitable data structure that sets forth parameters for scheduling data scrubbing for its associated storage resource 114. For example, data scrubbing parameters 116 may include a frequency at which data scrubbing operations for the associated storage resource are to be executed, the duration of each data scrubbing operation, and/or other suitable variables. Timer 118 may include any system, device, or apparatus configured to determine when data scrubbing operations are to execute based on reference to data scrubbing parameters 116

Although FIG. 1 depicts each storage resource 114 having its own data scrubbing parameters 116, in some embodiments, more than one storage resource 114 may share the same data scrubbing parameters 116, including embodiments in which all storage resources 114 of storage array 110 share the same data scrubbing parameters 116.

As depicted in FIG. 1, storage resources 114 may each be coupled to a management controller 112 via a management bus 108. Management controller 112 may be any system, device, or apparatus configured to, based on data scrubbing parameters 116 and/or other messages communicated from storage resources 114, power up storage resources 114 from a standby state in order to perform data scrubbing operations and power down storage resources 114 when such data scrubbing operations have ended, as described in greater detail below. In some embodiments, management controller 112 may comprises a management controller configured to permit an administrator or other person to remotely monitor and/or remotely manage storage array 110 (e.g., via an information handling system remotely connected to storage array 110 via a network). In certain embodiments, management controller 112 may allow for “out-of-band” control of storage resources 114, such that communications to and from management controller 112 are communicated via a management channel physically isolated from an “in band” communication channel for non-management traffic associated with storage array 110. In other embodiments, management controller 112 may allow for in-band control of storage resources 114. In certain embodiments, management controller 112 may include or may be an integral part of an access controller, a service processor, or other suitable device.

As shown in FIG. 1, management controller 112 may include a timer 113. Timer 113 may include any system, device, or apparatus configured to determine when data scrubbing operations are to execute based on data scrubbing parameters 116 communicated to management controller 112 by storage resources 114. In some embodiments, timer 113 may be identical or similar to timers 118 of storage resources 114. In these and other embodiments, management controller 112 may include multiple timers 113 (e.g., in the event system 100 includes a plurality of storage resources 114 for which management controller 112 may manage).

Management bus 108 may comprise any system, device, or apparatus configured to transfer data between storage resources 114 and management controller 112. Management bus 108 may comprise parallel electrical wires with multiple connections or any physical arrangement that provides the same logical functionality as a parallel electrical bus (e.g., parallel, bit-serial, multidrop, daisy chain, switched hubs, etc.). In some embodiments, management bus 108 may include may comprise a Peripheral Component Interconnect Express (PCIe) bus, System Management Bus (SMBus), Serial Attached Small Computer System Interface (SAS), or another suitable bus.

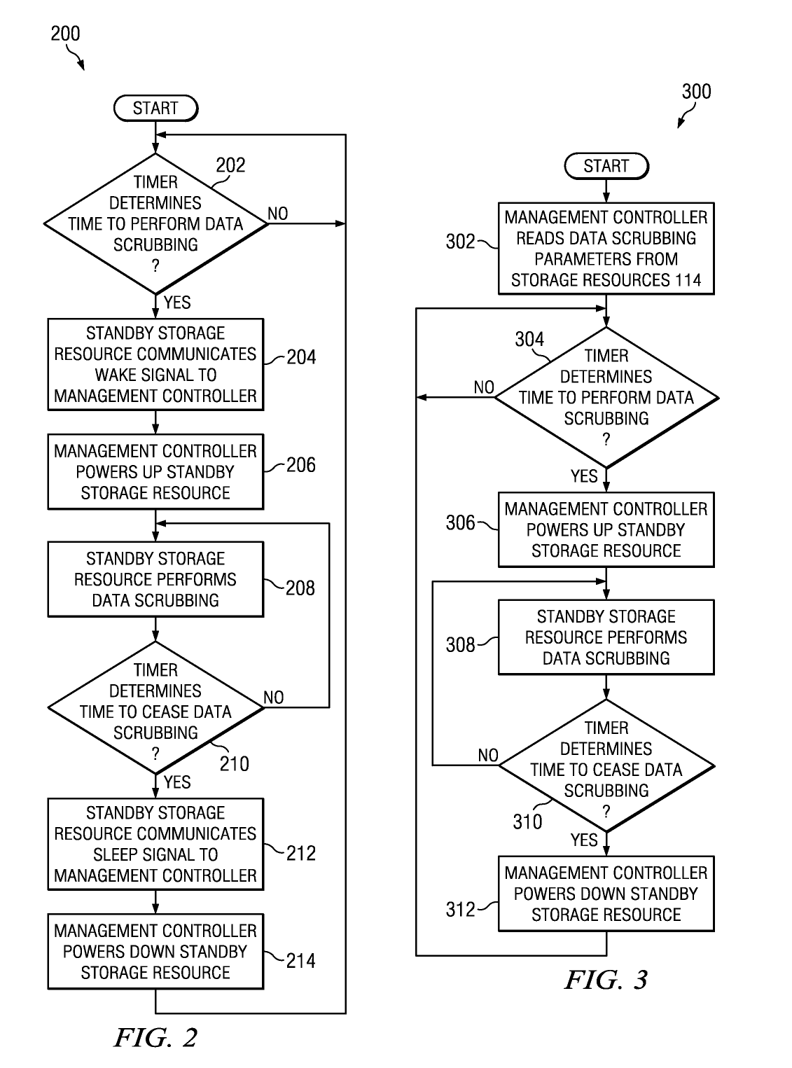

In operation, management controller 112 may, in concert with storage resources 114, assure performance of data scrubbing operations for storage resources 114 in a low-power standby mode by powering up and powering down storage resource 114 in accordance with schedules defined by their respective data scrubbing parameters 116. In accordance with this disclosure, data scrubbing of standby storage resources may be performed via a storage resource-initiated data scrubbing operation (e.g., as set forth below with respect to FIG. 2 and its accompanying description) and/or via a management controller-initiated data scrubbing operation (e.g., as set forth below with respect to FIG. 3 and its accompanying description).

As used herein, a storage resource in a standby state or a standby storage resource refers to a storage resource that is maintained in a low-power state in which the storage resource consumes lesser power than in a normal power state that the storage resource utilizes for performing input (I/O) operations (e.g., reads, writes, data scrubbing, etc.). Such low-power state may permit a standby storage resource to have limited functionality, such as an ability to communicate and receive management traffic via management bus 108, but not perform I/O operations, while in the normal power state the storage resource may be able to perform I/O operations and conduct management-related communications.

FIG. 2 illustrates a flow chart of an example method 200 for a storage resource-initiated data scrubbing operation of a standby storage resource, in accordance with the present disclosure. According to one embodiment, method 200 may begin at step 202. As noted above, teachings of the present disclosure may be implemented in a variety of configurations of system 100. As such, the preferred initialization point for method 200 and the order of the steps 202-214 comprising method 200 may depend on the implementation chosen.

At step 202, a timer 118 of a standby storage resource 114 may, in accordance with one or more data scrubbing parameters 116 (e.g., a frequency), determine whether a data scrubbing operation for the storage resource 114 is to execute. If timer 118 determines that data scrubbing is to execute, method 200 may proceed to step 204. Otherwise, method 200 may remain at step 202 until timer 118 indicates that a data scrubbing operation is scheduled to occur in accordance with data scrubbing parameters 116.

At step 204, in response to a determination that data scrubbing is scheduled to begin, standby storage resource 114 may communicate (e.g., via management bus 108) a “wake” signal to management controller 112 indicating that data scrubbing is scheduled to begin. At this time, management controller 212 may also be in a low-power or standby state with limited functionality (e.g., limited to receiving “wake” or “sleep” signals via management bus 108 and/or other minor functionality), and receipt of the “wake” signal may cause management controller 112 to enter a normal power state where it may perform greater functionality.

At step 206, in response to receipt of the “wake” signal, management controller 112 may power up standby storage resource 114 to its normal power state. At step 208, the powered-up standby storage resource 114 may perform data scrubbing.

At step 210, a timer 118 of a standby storage resource 114 may, in accordance with one or more data scrubbing parameters 116 (e.g., a duration), determine whether a data scrubbing operation presently being executed for the storage resource 114 is to cease. If timer 118 determines that data scrubbing is to cease, method 200 may proceed to step 212. Otherwise, method 200 may proceed again to step 208, where method 200 may remain in the loop of steps 208 and 210 and data scrubbing may continue until timer 118 indicates that the data scrubbing operation is scheduled to cease in accordance with data scrubbing parameters 116.

At step 212, in response to a determination that data scrubbing is scheduled to cease, powered-up standby storage resource 114 may communicate (e.g., via management bus 108) a “sleep” signal to management controller 112 indicating that data scrubbing is scheduled to cease.

At step 214, in response to the sleep signal, management controller 112 may power down the standby storage resource 114 such that it returns to its low-power state. In some embodiments, receipt of the sleep signal may cause management controller 112 to transition from its normal-power state to a low-power state. After completion of step 214, method 200 may proceed again to step 202, where method 200 may begin again.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using system 100 or any other system operable to implement method 200. In certain embodiments, method 200 may be implemented partially or fully in software and/or firmware embodied in computer-readable media.

FIG. 3 illustrates a flow chart of an example method 300 for a management controller-initiated data scrubbing operation of a standby storage resource, in accordance with the present disclosure. According to one embodiment, method 300 may begin at step 302. As noted above, teachings of the present disclosure may be implemented in a variety of configurations of system 100. As such, the preferred initialization point for method 300 and the order of the steps 302-312 comprising method 300 may depend on the implementation chosen.

At step 302, a management controller 112 may read data scrubbing parameters 116 from one or more storage resources 114 via management bus 108. Such reading of data scrubbing parameters may occur during an initial startup and/or other initialization of storage array 110.

At step 304, timer 113 of management controller 112 may, in accordance with the one or more data scrubbing parameters 116 received at step 302 (e.g., a frequency), determine whether a data scrubbing operation for a standby storage resource 114 is to execute. If timer 113 determines that data scrubbing is to execute, method 300 may proceed to step 306. Otherwise, method 300 may remain at step 304 until timer 113 indicates that a data scrubbing operation is scheduled to occur in accordance with data scrubbing parameters 116.

At step 306, in response to a determination that data scrubbing is scheduled to begin, management controller 112 may power up standby storage resource 114 to its normal power state. At step 308, the powered-up standby storage resource 114 may perform data scrubbing. Storage resource 114 may commence data scrubbing upon startup, or may begin scrubbing in response to an appropriate command received from management controller 112 after powering up.

At step 310, timer 113, in accordance with one or more data scrubbing parameters 116 received at step 302 (e.g., a duration), determine whether a data scrubbing operation presently being executed for a storage resource 114 is to cease. If timer 113 determines that data scrubbing is to cease, method 200 may proceed to step 312. Otherwise, method 200 may proceed again to step 308, where method 300 may remain in the loop of steps 308 and 310 and data scrubbing may continue until timer 113 indicates that the data scrubbing operation is scheduled to cease in accordance with data scrubbing parameters 116.

At step 312, in response to a determination that data scrubbing is scheduled to cease, management controller 112 may power down the standby storage resource 114 such that it returns to its low-power state. After completion of step 312, method 300 may proceed again to step 304, where the loop of steps 304-312 may begin again.

Although FIG. 3 discloses a particular number of steps to be taken with respect to method 300, method 300 may be executed with greater or lesser steps than those depicted in FIG. 3. In addition, although FIG. 3 discloses a certain order of steps to be taken with respect to method 300, the steps comprising method 300 may be completed in any suitable order.

Method 300 may be implemented using system 100 or any other system operable to implement method 300. In certain embodiments, method 300 may be implemented partially or fully in software and/or firmware embodied in computer-readable media.

Although the present disclosure has been described in detail, it should be understood that various changes, substitutions, and alterations can be made hereto without departing from the spirit and the scope of the disclosure as defined by the appended claims.

What is claimed is:

1. A storage array comprising:
a management controller; and
at least one storage resource communicatively coupled to the management controller and configured to operate in each of:
a normal-power mode, in which the storage resource consumes sufficient power to perform input/output (I/O) operations; and
a low-power mode, in which the storage resource consumes sufficient power to perform management operations but not I/O operations;
the at least one storage resource having associated therewith at least one data scrubbing parameter defining a schedule for data scrubbing operations of the at least one storage resource; and
the management controller and the at least one storage resource further configured to:
cause the at least one storage resource to transition from the low-power mode to the normal-power mode in order to perform a data scrubbing operation in response to a determination based on the at least one data scrubbing parameter that the at least one storage resource is scheduled for a data scrubbing operation; and
cause the at least one storage resource to transition from the normal-power mode to the low-power mode in response to a determination based on the at least one data scrubbing parameter that the data scrubbing operation is scheduled to cease.

2. A storage array according to claim 1, wherein the management controller is further configured to:
read the at least one data scrubbing parameter associated with the at least one storage resource via a management bus;
determine whether the at least one storage resource is scheduled for data scrubbing based on the at least one data scrubbing parameter;
cause the at least one storage resource to transition from the low-power mode to the normal-power mode in order to perform the data scrubbing operation in response to the determination that the at least one storage resource is scheduled for a data scrubbing operation;
determine whether the data scrubbing operation is scheduled to cease based on the at least one data scrubbing parameter; and
cause the at least one storage resource to transition from the normal-power mode to the low-power mode in response to a determination that the data scrubbing operation is scheduled to cease.

3. A storage array according to claim 1, wherein the at least one data parameter comprises a frequency at which data scrubbing operations are to execute for the at least one storage resource.

4. A storage array according to claim 1, wherein the at least one data parameter comprises a duration for which data scrubbing operations are to execute for the at least one storage resource.

5. A storage array according to claim 1, wherein the at least one storage resource comprises a solid state storage device.

6. A storage array according to claim 1, wherein the at least one storage resource is further configured to:
determine whether the at least one storage resource is scheduled for data scrubbing based on the at least one data scrubbing parameter;
communicate a first signal to the management controller in response to the determination that the at least one storage resource is scheduled for a data scrubbing operation;
determine whether the data scrubbing operation is scheduled to cease based on the at least one data scrubbing parameter; and
communicate a second signal to the management controller in response to a determination that the data scrubbing operation is scheduled to cease.

7. A storage array according to claim 6, the management controller further configured to:
cause the at least one storage resource to transition from the low-power mode to the normal-power mode in order to perform the data scrubbing operation in response to receipt of the first signal; and
cause the at least one storage resource to transition from the normal-power mode to the low-power mode in response to receipt of the second signal.

8. An information handling system comprising:
a processor;
a management controller; and
at least one storage resource communicatively coupled to the processor and the management controller and configured to operate in each of:
a normal-power mode, in which the storage resource consumes sufficient power to perform input/output (I/O) operations; and
a low-power mode, in which the storage resource consumes sufficient power to perform management operations but not I/O operations;
the at least one storage resource having associated therewith at least one data scrubbing parameter defining a schedule for data scrubbing operations of the at least one storage resource; and
the management controller and the at least one storage resource further configured to:
cause the at least one storage resource to transition from the low-power mode to the normal-power mode in order to perform a data scrubbing operation in response to a determination based on the at least one data scrubbing parameter that the at least one storage resource is scheduled for a data scrubbing operation; and
cause the at least one storage resource to transition from the normal-power mode to the low-power mode in response to a determination based on the at least one data scrubbing parameter that the data scrubbing operation is scheduled to cease.

9. An information handling system according to claim 8, wherein the management controller is further configured to:
read the at least one data scrubbing parameter associated with the at least one storage resource via a management bus;
determine whether the at least one storage resource is scheduled for data scrubbing based on the at least one data scrubbing parameter;
cause the at least one storage resource to transition from the low-power mode to the normal-power mode in order to perform the data scrubbing operation in response to the determination that the at least one storage resource is scheduled for a data scrubbing operation;
determine whether the data scrubbing operation is scheduled to cease based on the at least one data scrubbing parameter; and
cause the at least one storage resource to transition from the normal-power mode to the low-power mode in response to a determination that the data scrubbing operation is scheduled to cease.

10. An information handling system according to claim 8, wherein the at least one data parameter comprises a frequency at which data scrubbing operations are to execute for the at least one storage resource.

11. An information handling system according to claim 8, wherein the at least one data parameter comprises a duration for which data scrubbing operations are to execute for the at least one storage resource.

12. An information handling system according to claim 8, wherein the at least one storage resource comprises a solid state storage device.

13. An information handling system according to claim 8, wherein the at least one storage resource is further configured to:
determine whether the at least one storage resource is scheduled for data scrubbing based on the at least one data scrubbing parameter;
communicate a first signal to the management controller in response to the determination that the at least one storage resource is scheduled for a data scrubbing operation;
determine whether the data scrubbing operation is scheduled to cease based on the at least one data scrubbing parameter; and
communicate a second signal to the management controller in response to a determination that the data scrubbing operation is scheduled to cease.

14. An information handling system according to claim 13, the management controller further configured to:
cause the at least one storage resource to transition from the low-power mode to the normal-power mode in order to perform the data scrubbing operation in response to receipt of the first signal; and
cause the at least one storage resource to transition from the normal-power mode to the low-power mode in response to receipt of the second signal.

15. An information handling system according to claim 8, wherein:
the at least one storage array is communicatively coupled to the management controller via a management bus; and
the at least one storage array is communicatively coupled to the processor via a management bus.

16. A method comprising:
determining based on at least one data scrubbing parameter associated with at least one storage resource that the at least one storage resource is scheduled for a data scrubbing operation;
cause the at least one storage resource to transition from a low-power mode to a normal-power mode in order to perform a data scrubbing operation in response to a determination that the at least one storage resource is scheduled for a data scrubbing operation;
determining based on the at least one data scrubbing parameter that the data scrubbing operation is scheduled to cease; and
causing the at least one storage resource to transition from the normal-power mode to the low-power mode in response to a determination that the data scrubbing operation is scheduled to cease;
wherein:
in the normal-power mode, the storage resource consumes sufficient power to perform input/output (I/O) operations; and
in the low-power mode, the storage resource consumes sufficient power to perform management operations but not I/O operations.

17. A method according to claim 16, further comprising communicating the at least one data scrubbing parameter associated with the at least one storage resource to a management controller via a management bus, wherein the determining and causing steps are performed by the management controller based on the received at least one data scrubbing parameter.

18. A method according to claim 16, further comprising:
communicating a first signal from the at least one storage resource to the management controller in response to the determination that the at least one storage resource is scheduled for a data scrubbing operation;
causing the at least one storage resource to transition from the low-power mode to the normal-power mode in order to perform the data scrubbing operation in response to receipt of the first signal;
communicating a second signal from the at least one storage resource to the management controller in response to a determination that the data scrubbing operation is scheduled to cease; and
causing the at least one storage resource to transition from the normal-power mode to the low-power mode in response to receipt of the second signal.

19. A method according to claim 16, wherein the at least one data parameter comprises at least one of:
a frequency at which data scrubbing operations are to execute for the at least one storage resource; and
a duration for which data scrubbing operations are to execute for the at least one storage resource.

20. A method according to claim 16, wherein the at least one storage resource comprises a solid state storage device.
